(19) United States
(12) Patent Application Publication
(10) Pub. No.: US 2015/0042367 A1
(43) Pub. Date: Feb. 12, 2015

(54) THICKNESS MEASUREMENT DEVICE AND METHOD FOR MEASURING THICKNESS

(71) Applicant: SAMSUNG ELECTRO-MECHANICS CO., LTD., Suwon-si (KR)

(72) Inventors: Ji Hoon KIM, Suwon-si (KR); Sung Yeol Park, Suwon-si (KR)

(73) Assignee: SAMSUNG ELECTRO-MECHANICS CO., LTD., Suwon-si (KR)

(21) Appl. No.: 14/331,168

(22) Filed: Jul. 14, 2014

(30) Foreign Application Priority Data
Aug. 6, 2013 (KR) 10-2013-0093100

(51) Int. Cl. G01B 7/06

(52) U.S. Cl. CPC G01B 7/06
USPC 324/699

(57) ABSTRACT

Disclosed herein are a thickness measurement device and a method for measuring a thickness. The thickness measurement device includes: a four-terminal probe including a first probe through a fourth probe which are in contact with a metal film; a contact pressure controlling unit each controlling the first probe through the fourth probe so that the metal film and the first probe through the fourth probe have the same contact pressure; a current supplying unit supplying a current to the four-terminal probe; a voltage measuring unit measuring a voltage across the four-terminal probe; and a thickness calculating unit calculating a thickness of the metal film using a current value supplied from the current supplying unit and a voltage value measured by the voltage measuring unit.

### CROSS REFERENCE TO RELATED APPLICATION

This application claims the benefit of Korean Patent Application No. 10-2013-0093100, filed on Aug. 6, 2013, entitled “Thickness Measurement Device and Method for Measuring the Same”, which is hereby incorporated by reference in its entirety into this application.

### BACKGROUND OF THE INVENTION

1. Technical Field

The present invention relates to a thickness measurement device and a method for measuring a thickness.

2. Description of the Related Art

Recently, a trend of multifunctional and high-speed electronic products has progressed at a rapid speed. In order to cope with this trend, semiconductor chips and a printed circuit board having the semiconductor chips mounted thereon have also been developed at a very rapid speed. The above-mentioned printed circuit board is required to have characteristics such as slimness and lightness, fine circuit excellent electrical characteristic, high reliability, high-speed signal transmission, and the like.

A process of measuring a thickness of a circuit pattern among processes of the printed circuit board is very important factor in managing a board manufacturing process and determining electrical characteristic of the board. A method for measuring the thickness of the circuit pattern includes a destructive method and a non-destructive method. The destructive method cuts a sample in a thickness direction and then measures the thickness of the sample using an electron microscope. The method for measuring the thickness of the sample using the electron microscope takes a long time in preparing the sample and needs to destroy the sample in order to measure the thickness thereof. In addition, this method is unsuitable for measuring distribution of the thickness. As the non-destructive method, a method in which a resistance value of the circuit pattern is affected by the thickness is used (U.S. Pat. No. 6,407,546). Typically, a four point probe (FPP) method has been used. However, the non-destructive method is not a method for measuring the thickness after cutting the sample, thereby generating an error in a plating thickness measurement depending on a degree of roughness and bending when measuring the thickness of the circuit pattern.

### SUMMARY OF THE INVENTION

The present invention has been made in an effort to provide a thickness measurement device and a method for measuring a thickness for accurately measuring a thickness of a metal film.

According to a preferred embodiment of the present invention, there is provided a thickness measurement device, including: a four-terminal probe including a first probe through a fourth probe which are in contact with a metal film; a contact pressure controlling unit each controlling the first probe through the fourth probe so that the metal film and the first probe through the fourth probe have the same contact pressure; a current supplying unit supplying a current to the four-terminal probe; a voltage measuring unit measuring a voltage across the four-terminal probe; and a thickness calculating unit calculating a thickness of the metal film using a current value supplied from the current supplying unit and a voltage value measured by the voltage measuring unit.

The contact pressure controlling unit may include: a contact pressure measuring unit measuring contact pressure each applied to the first probe through the fourth probe from the metal film; a contact pressure comparing unit comparing the respective contact pressure of the first probe through the fourth probe measured from the contact pressure measuring unit; and a load controlling unit selectively controlling loads applied to the first probe through the fourth probe depending on a result of the contact pressure comparing unit.

The load controlling unit may include load controlling units selectively connected to the first probe through the fourth probe, respectively.

The thickness measurement device may further include variable units each formed on the first probe through the fourth probe to thereby allow the first probe through the fourth probe to be in contact with a surface of the metal film.

The variable unit may be made of elastic material.

The thickness measurement device may further include a timer generating a measurement start signal controlling a thickness measurement point in time of the metal film, when the first probe through the fourth probe have the same contact pressure.

The timer may transmit the measurement start signal to the current supplying unit.

The current supplying unit may supply the current to the four-terminal probe when receiving the measurement start signal.

The timer may transmit the measurement start signal to the voltage measuring unit.

The voltage measuring unit may measure the voltage applied to the four-terminal probe when receiving the measurement start signal.

The thickness calculating unit may calculate the thickness of the metal film using a sheet resistance value calculated using the current value and the voltage value and a specific resistance value of the metal film.

The current supplying unit may supply the current to the metal film through two probes of the four-terminal probe.

The voltage measuring unit may measure the voltage applied to two probes of the four-terminal probe.

According to another preferred embodiment of the present invention, there is provided a method for measuring a thickness, the method including: contacting a metal film with a four-terminal probe including a first probe through a fourth probe; controlling contact pressure between the metal film and the first probe through the fourth probe so as to be equal; supplying a current to the four-terminal probe; measuring a voltage applied to the four-terminal probe; and calculating a thickness of the metal film using a current value and a voltage value.

The controlling of the contact pressure so as to be equal may include: measuring contact pressure each applied to the first probe through the fourth probe from the metal film; comparing the measured contact pressure of the first probe through the fourth probe; and controlling loads each applied to the first probe through the fourth probe depending on a result of the comparison.

The controlling of the contact pressure so as to be equal may be repeatedly performed until the measured contact pressure of the first probe through the fourth probe are equal.

In the contacting of the metal film with the four-terminal probe, the first probe through the fourth probe may be in contact with a surface of the metal film.

In the contacting of the metal film with the four-terminal probe, the first probe through the fourth probe may have variable bodies so as to be in contact with a surface of the metal film.

The variable bodies of the first probe through the fourth probe may be formed of elastic material.

The method may further include, after the controlling of the contact pressure so as to be equal, generating a measurement start signal controlling a thickness measurement point in time of the metal film when the contact pressure of the first probe through the fourth probe are equal.

In the measuring of the thickness of the metal film, a thickness of the metal film may be calculated using a sheet resistance value calculated using the current value and the voltage value and a specific resistance value of the metal film.

In the supplying of the current, the current may be applied to the metal film through two probes of the four-terminal probe.

In the measuring of the voltage, the voltage applied to two probes of the four-terminal probe may be measured.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a block diagram showing a thickness measurement device according to a preferred embodiment of the present invention;

FIG. 2 is an illustration view showing a four-terminal probe according to a preferred embodiment of the present invention;

FIG. 3 is a block diagram showing a contact pressure controlling unit according to a preferred embodiment of the present invention;

FIG. 4 is a flow chart showing a method for measuring a thickness according to a preferred embodiment of the present invention;

FIG. 5 is a block diagram showing a thickness measurement device according to another preferred embodiment of the present invention; and

FIG. 6 is an illustration view showing a method for measuring a thickness according to another preferred embodiment of the present invention.

### DESCRIPTION OF THE PREFERRED EMBODIMENTS

The objects, features and advantages of the present invention will be more clearly understood from the following detailed description of the preferred embodiments taken in conjunction with the accompanying drawings. Throughout the accompanying drawings, the same reference numerals are used to designate the same or similar components, and redundant descriptions thereof are omitted. Further, in the following description, the terms “first”, “second”, “one side”, “the other side” and the like are used to differentiate a certain component from other components, but the configuration of such components should not be construed to be limited by the terms. Further, in the description of the present invention, when it is determined that the detailed description of the related art would obscure the gist of the present invention, the description thereof will be omitted.

Hereinafter, preferred embodiments of the present invention will be described in detail with reference to the accompanying drawings.

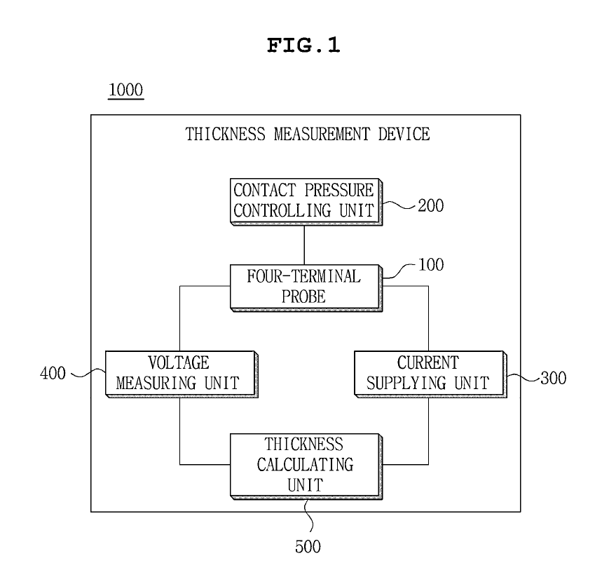

FIG. 1 is a block diagram showing a thickness measurement device according to a preferred embodiment of the present invention.

Referring to FIG. 1, the thickness measurement device 1000 may be configured to include a four-terminal probe 100, a contact pressure controlling unit 200, a current supplying unit 300, a voltage measuring unit 400, and a thickness calculating unit 500.

The four-terminal probe 100 is in contact with a metal film in order to calculate a thickness of the metal film. The metal film may be a circuit pattern formed on a printed circuit board. However, the metal film is not limited to the circuit pattern and the present invention may also be applied to anything capable of measuring the thickness by a four point probe (FPP) method. The four-terminal probe 100 may be configured by four probes. Two probes of the four probes may supply a current from the current supplying unit 300 to the metal film. The remaining two probes may be applied with a voltage generated by the current supplied to the metal film.

The contact pressure controlling unit 200 may control all the four probes so as to have the same contact resistance as the metal film. The contact pressure controlling unit 200 may measure contact pressure of the four probes and then compare the measured contact pressure to one another to determine whether all the four probes have the same contact pressure. When all the contact pressure across the four probes are not equal, the contact pressure controlling unit 200 may adjust a load of each of the four probes so that the contact pressure are equal to one another. The contact pressure controlling unit 200 may repeatedly perform a contact pressure measurement and a load control until the contact pressure across the four probes is equal to one another.

The current supplying unit 300 may supply a current to the four-terminal probe 100. The current supplying unit 300 may supply the current to the metal film through the two probes of the four-terminal probe 100.

The voltage measuring unit 400 may measure a voltage applied to the four-terminal probe 100. The voltage applied to the four-terminal probe 100 is an applied voltage of the metal film generated by supplying the current. Therefore, the voltage measuring unit 400 may measure the voltage of the metal film by measuring the voltage across the four-terminal probe 100. The voltage measuring unit 400 may measure the voltage across the two probes of the four-terminal probe 100. Here, the probes at which the voltage is measured are the two probes except for the two probes to which the current is supplied.

The thickness calculating unit 500 may calculate the thickness of the metal film. The thickness calculating unit 500 may calculate the thickness of the metal film using the current supplied from the current supplying unit 300 and the voltage measured by the voltage measuring unit. The thickness calculating unit 500 may calculate a resistance value of the metal film using a current value of the current supplying unit 300 and a voltage value of the voltage measuring unit 400. In addition, the thickness calculating unit 500 may multiply the resistance value of the metal film with a correction factor of the corresponding metal film to thereby calculate a sheet resistance value. In addition, the thickness calculating unit 500 may divide a specific resistance value by the calculated sheet resistance value to thereby calculate the thickness of the metal film.

When measuring the thickness of the metal film, the contact pressure between the respective probes and the metal film may be varied depending on a degree of roughness and bending of the metal film. In the case in which the contact pressure between the metal film and the respective probes are different, contact resistances may also be different. Therefore, in the case in which the contact pressure between the metal film and the respective probes are different from each other, an error may be generated between the voltage measured from the metal film and a practical voltage. Since the thickness measurement device 1000 measures the thickness using the voltage generated from the metal film, an error may be generated between the measured thickness and a practical thickness due to an error caused by the contact pressure. Therefore, in order to accurately calculate the thickness even in a case of the roughness or the bending of the metal film, all the contact pressure between the metal film and a plurality of probes need to be equal.

The thickness measurement device 1000 according to the preferred embodiment of the present invention controls the contact resistances between the four-terminal probe 100 and the metal film so as to be equal by the contact pressure controlling unit 200 when calculating the thickness of the metal film using the four-terminal probe 100, thereby making it possible to accurately calculate the thickness of the metal film.

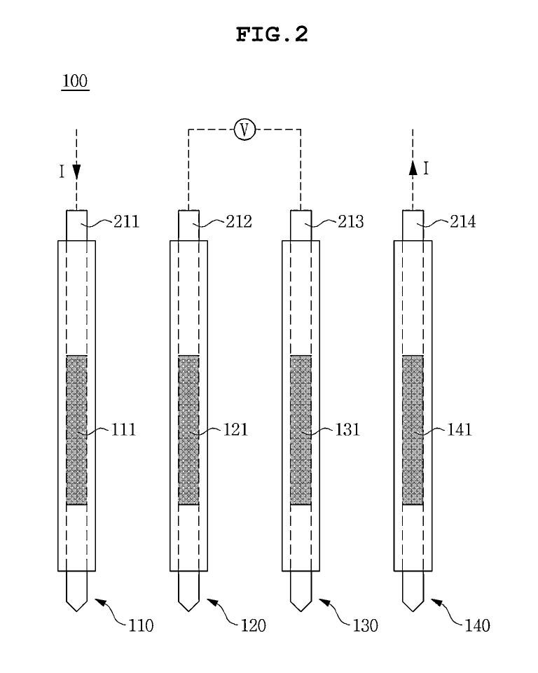

FIG. 2 is an illustration view showing a four-terminal probe according to a preferred embodiment of the present invention.

Referring to FIG. 2, the four-terminal probe 100 may include a first probe 110 through a fourth probe 140.

All of the first probe 110 through the fourth probe 140 may be in contact with the metal film. Two probes of the first probe 110 through the fourth probe 140 may apply a current to the metal film. The remaining two probes may be applied with a voltage across the metal film applied with the current. In general, the first probe 110 and the fourth probe 140 positioned at both ends among the four-terminal probe 100 may apply the current to the metal film, and the second probe 120 and the third probe 130 positioned at a middle may be applied with the voltage across the metal film.

The four-terminal probe 100 may include a first variable unit 111, a second variable unit 121, a third variable unit 131, and a fourth variable unit 141, respectively. The first variable unit 111 through the fourth variable unit 141 may be formed on the respective bodies of the first probe 110 through the fourth probe 140. For example, the first variable unit 111 through the fourth variable unit 141 may be formed of a material having elastic force such as a spring. By the elastic force of the first variable unit 111 through the fourth variable unit 141, the first probe 110 through the fourth probe 140 may be in contact with a surface of the metal film.

One end of the first probe 110 through the fourth probe 140 may be in contact with the surface of the metal film. The first probe 110 through the fourth probe 140 may have a first pressure measuring unit 211 through a fourth pressure measuring unit 214 positioned at the other end thereof. The first pressure measuring unit 211 through the fourth pressure measuring unit 214 are to measure the contact pressure between the first probe 110 through the fourth probe 140 and the metal film. According to the preferred embodiment of the present invention, the first pressure measuring unit 211 through the fourth pressure measuring unit 214 are attached to the first probe 110 through the fourth probe 140, but are not a configuration included in the four-terminal probe 100. The first pressure measuring unit 211 through the fourth pressure measuring unit 214 are the configuration included in the contact pressure controlling unit (210 in FIG. 1), but are not limited thereto, and may be included in another configuration unit and may be an independent configuration unit.

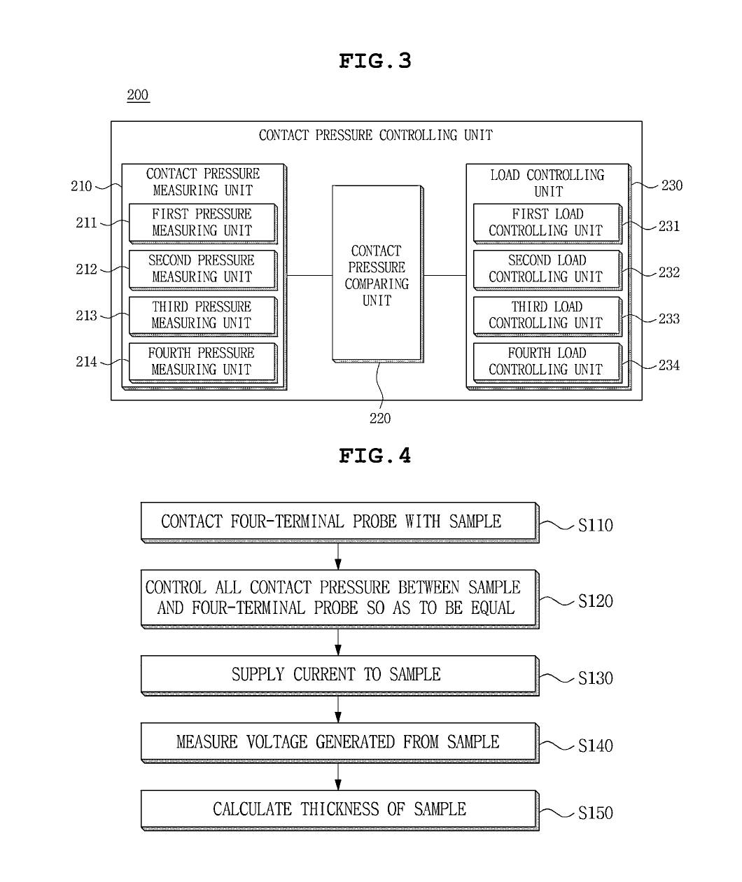

FIG. 3 is a block diagram showing a contact pressure controlling unit according to a preferred embodiment of the present invention.

Referring to FIG. 3, the contact pressure controlling unit 200 may include a contact pressure measuring unit 210, a contact pressure comparing unit 220, and a load controlling unit 230.

The contact pressure measuring unit 210 may measure the contract pressures between the metal film and the first probe 110 through the fourth probe 140. For example, the contact pressure measuring unit 210 may be a unit capable of measuring the contact pressure such as a load cell, a pressure gauge, a piezoelectric device, or the like. The contact pressure measuring unit 210 may include the first pressure measuring unit 211 through the fourth pressure measuring unit 214. The first pressure measuring unit 211 through the fourth pressure measuring unit 214 may be formed at the first probe 110 through the fourth probe 140, respectively. For example, the first pressure measuring unit 211 may be formed at the first probe 110 to thereby control the contact pressure between the first probe 110 and the metal film. The second pressure measuring unit 212 may be formed at the second probe 120 to thereby control the contact pressure between the second probe 120 and the metal film. The third pressure measuring unit 213 may be formed at the third probe 130 to thereby control the contact pressure between the third probe 130 and the metal film. The fourth pressure measuring unit 214 may be formed at the fourth probe 140 to thereby control the contact pressure between the fourth probe 140 and the metal film. According to the preferred embodiment of the present invention, in the case in which one end of the first probe 110 through the fourth probe 140 are in contact with the metal film, the first probe 110 through the fourth probe 140 may have the first pressure measuring unit 211 through the fourth pressure measuring unit 214 positioned at the other end thereof. However, the position of the first pressure measuring unit 211 through the fourth pressure measuring unit 214 is not limited thereto. That is, the first pressure measuring unit 211 through the fourth pressure measuring unit 214 may be positioned at any locations as long as they may measure the contact pressure between the metal film and the first probe 110 through the fourth probe 140.

The contact pressure comparing unit 220 may compare the contact pressure measured by the first pressure measuring unit 211 through the fourth pressure measuring unit 214. According to the preferred embodiment of the present invention, the contact pressure measured by the first pressure measuring unit 211 through the fourth pressure measuring unit 214 refer to as first contact pressure through a fourth contact pressure, respectively.

The contact pressure comparing unit 220 may generate a load controlling signal in the case in which any one of the first contact pressure through the fourth contact pressure have a different value. The load controlling signal may be a signal adjusting loads across the first probe 110 through the fourth probe 140 so that the first contract pressure and the fourth contact pressure have the same value. The load controlling signal may include at least one data among a degree of decreasing the load, a degree of increasing the load, and load maintenance. The load controlling signal may include a first load controlling signal through a fourth load controlling signal corresponding to the first probe 110 through the fourth probe 140, respectively. For example, the contact pressure comparing unit 220 may determine that the second contact pressure and the third contact pressure are different from the first contact pressure and the fourth contact pressure as a result of comparing the first contact pressure through the fourth contact pressure with one another. In this case, in the case in which the second contact pressure needs to be decreased, the contract pressure comparing unit 220 may generate the second load controlling signal including the data with respect to the degree of decreasing the load of the second probe 120. In addition, in the case in which the third contact pressure needs to be increased, the contract pressure comparing unit 220 may generate the third load controlling signal including the data with respect to the degree of increasing the load of the third probe 130. In addition, the contract pressure comparing unit 220 may generate the first load controlling signal and the fourth load controlling signal including the data with respect to the load maintenance of the first probe 110 and the fourth probe 140.

The contact pressure comparing unit 220 may compare the first contact pressure through the fourth contact pressure with one another in various methods. For example, the contact pressure comparing unit 220 may compare the remaining contact pressure based on a predetermined contact pressure across one probe to thereby generate the load controlling signal with respect to each of the probes. Alternatively, the contact pressure comparing unit 220 may compare the remaining contact pressure based on the lowest or highest contact pressure among the measured contact pressure to thereby generate the load controlling signal with respect to each of the probes. Alternatively, the contact pressure comparing unit 220 may compare the contact pressure based on an average value of the measured contact pressure to thereby generate the load controlling signal with respect to each of the probes. The contact pressure comparing unit 220 may select a reference contact pressure value and compare the reference contact pressure value with the measured contact pressure to thereby generate the load controlling signal by the above-mentioned methods as well as various methods.

The contact pressure comparing unit 220 may transmit the first load controlling signal through the fourth load controlling signal generated as described above to the load controlling unit 230 controlling the loads of the first probe 110 through the fourth probe 140.

The load controlling unit 230 may selectively control the loads across the first probe 110 through the fourth probe 140, respectively, depending on the load controlling signal received from the contact pressure comparing unit 220. The load controlling unit 230 may include a first load controlling unit 231 through a fourth load controlling unit 234. The first load controlling unit 231 may adjust the load across the first probe 110 depending on the first load controlling signal. The second load controlling unit 232 may adjust the load across the second probe 120 depending on the second load controlling signal. The third load controlling unit 233 may adjust the load across the third probe 130 depending on the third load controlling signal. The fourth load controlling unit 234 may adjust the load across the fourth probe 140 depending on the fourth load controlling signal.

FIG. 4 is a flow chart showing a method for measuring a thickness according to a preferred embodiment of the present invention.

FIG. 4 shows the method for measuring the thickness of the metal film using the thickness measurement device according to the preferred embodiment of the present invention.

First, the thickness measurement device may contact the four-terminal probe with the metal film (S110). For example, the metal film may be a circuit pattern formed on a printed circuit board. The four-terminal probe may be configured by the first probe through the fourth probe. In this case, the first probe through the fourth probe may be configured so as to include variable units having elastic force. The first probe through the fourth probe may be in contact with the surface of the metal film by the variable units.

Next, the thickness measurement device may control all the contact pressure between the four-terminal probe and the metal film so as to be equal (S120). The thickness measurement device may each measure the contact pressure applied to the first probe through the fourth probe from the metal film. Here, the contact pressure of the first probe through the fourth probe may be the first contact pressure through the fourth contact pressure. The thickness measurement device may compare the first contact pressure through the fourth contact pressure to thereby determine whether or not all the first contact pressure through the fourth contact pressure are equal. When all the first contact pressure through the fourth contact pressure are not equal, the thickness measurement device may adjust the contact pressure across each probe so as to be equal by adjusting the loads of the first probe through the fourth probe. The thickness measurement device may adjust the contact pressure so that the first probe through the fourth probe have the same contact pressure using various method as described in FIG. 3.

Next, the thickness measurement device may supply the current to the metal film (S130). In the case in which all the first probe through the fourth probe have the same contact pressure, the thickness measurement device may supply the current to the four-terminal probe which is in contact with the metal film. The thickness measurement device may supply the current to the metal film through two probes of the first probe through the fourth probe.

Next, the thickness measurement device may measure a voltage generated from the metal film (S140). The thickness measurement device may measure the voltage generated from the metal film by the current supplied to the metal film. In this case, the voltage generated from the metal film may be applied to the two probes of the four-terminal probe. Therefore, the voltage measuring unit may measure the voltage generated from the metal film by measuring the voltage across the two probes.

Next, the thickness measurement device may calculate the thickness of the metal film (S150). The thickness measurement device may calculate the thickness of the metal film using the current supplied to the metal film and the voltage measured from the metal film. The thickness measurement device may calculate a resistance value of the metal film using the current value and the voltage value described above. In addition, the thickness measurement device may multiply the resistance value of the metal film with a correction factor of the corresponding metal film to thereby calculate a sheet resistance value. The thickness measurement device may divide a specific resistance value of the metal film by the calculated sheet resistance value to thereby calculate the thickness of the metal film.

The method for measuring the thickness according to the preferred embodiment of the present invention may decrease an error in the thickness caused by the different contact resistance between the metal film and the four-terminal probe by the adjusting of the contact pressure between the metal film and the four-terminal probe so as to be equal.

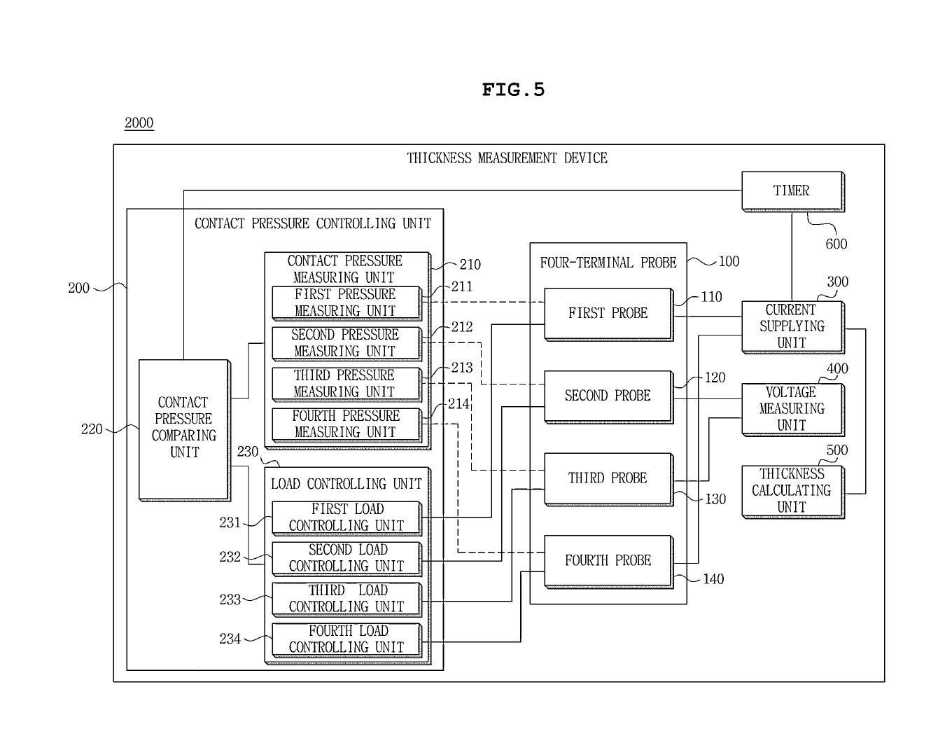

FIG. 5 is a block diagram showing a thickness measurement device according to another preferred embodiment of the present invention.

Referring to FIG. 5, the thickness measurement device 2000 may be configured to include a four-terminal probe 100, a contact pressure controlling unit 200, a timer 600, a current supplying unit 300, a voltage measuring unit 400, and a thickness calculating unit 500.

The four-terminal probe 100 is in contact with a metal film in order to calculate a thickness of the metal film. Here, the metal film is a thickness measurement target. For example, the metal film may be a circuit pattern formed on a printed circuit board.

The four-terminal probe 100 may include a first probe 110 through a fourth probe 140. All the first probe 110 through the fourth probe 140 may be in contact with the metal film. For example, the first probe 110 and the fourth probe 140 positioned at both ends of the four-terminal probe 100 may supply a current to the metal film. In addition, the second probe 120 and the third probe 130 positioned at a middle of the four-terminal probe 100 may be applied with a voltage across the metal film.

Although not shown in FIG. 5, variable units may be included in the four-terminal probe 100. The variable units may be formed on bodies of the first probe 110 through the fourth probe 140, respectively. For example, the variable units may be formed of a material having elastic force such as a spring. By the elastic force of the variable units, all the four-terminal probe 100 may be in contact with a surface of the metal film.

The contact pressure controlling unit 200 may control the four-terminal probe 100 so that all the first probe 110 through the fourth probe 140 have the same contact pressure as the metal film. The contact pressure controlling unit 200 may control the respective loads to thereby make the contact pressure equal to one another so that the contact pressure of the first probe 110 through the fourth probe 140 are equal. Since a contact resistance is affected by a magnitude of the contact pressure, if the contact pressure between the first probe 110 through the fourth probe 140 and the metal film are equal, then the contact resistance is also equal.

The contact pressure controlling unit 200 may include a contact pressure measuring unit 210, a contact pressure comparing unit 220, and a load controlling unit 230.

The contact pressure measuring unit 210 may measure the contract pressures between the metal film and the first probe 110 through the fourth probe 140. For example, the contact pressure measuring unit 210 may be a unit capable of measuring the contact pressure such as a load cell, a pressure gauge, a piezoelectric device, or the like. The contact pressure measuring unit 210 may include a first pressure measuring unit 211 through a fourth pressure measuring unit 214. The first pressure measuring unit 211 through the fourth pressure measuring unit 214 may be formed at the first probe 110 through the fourth probe 140, respectively. For example, the first pressure measuring unit 211 may be formed at the first probe 110 to thereby measure a first contact pressure between the first probe 110 and the metal film. The second pressure measuring unit 212 may be formed at the second probe 120 to thereby measure a second contact pressure between the second probe 120 and the metal film. The third pressure measuring unit 213 may be formed at the third probe 130 to thereby measure a third contact pressure between the third probe 130 and the metal film. The fourth pressure measuring unit 214 may be formed at the fourth probe 140 to thereby measure a fourth contact pressure between the fourth probe 140 and the metal film. According to the preferred embodiment of the present invention, in the case in which one end of the first probe 110 through the fourth probe 140 are in contact with the metal film, the first probe 110 through the fourth probe 140 may have the first pressure measuring unit 211 through the fourth pressure measuring unit 214 positioned at the other end thereof. However, the position of the first pressure measuring unit 211 through the fourth pressure measuring unit 214 is not limited thereto. That is, the first pressure measuring unit 211 through the fourth pressure measuring unit 214 may be positioned at any locations as long as they may measure the contact pressure between the metal film and the first probe 110 through the fourth probe 140.

The contact pressure comparing unit 220 may compare the contact pressure measured by the first pressure measuring unit 211 through the fourth pressure measuring unit 214. The contact pressure comparing unit 220 may generate a contact complete signal when the first contact pressure through the fourth contact pressure are equal. The contact pressure comparing unit 220 may transmit the generated contact complete signal to the timer 600.

The contact pressure comparing unit 220 may generate a load controlling signal in the case in which any one of the first contact pressure through the fourth contact pressure have a different value. The load controlling signal may be a signal adjusting loads across the first probe 110 through the fourth probe 140 so that the first contract pressure and the fourth contact pressure have the same value. The load controlling signal may include at least one data among a degree of decreasing the load, a degree of increasing the load, and load maintenance. The load controlling signal may include a first load controlling signal through a fourth load controlling signal corresponding to the first probe 110 through the fourth probe 140, respectively. For example, based on the first contact pressure, the fourth contact pressure may be measured to have the same value as the first contact pressure, and the second contact pressure and the third contact pressure may be measured to have values different from the first contact pressure. In this case, in the case in which the second contact pressure needs to be decreased, the contract pressure comparing unit 220 may generate the second load controlling signal including the data with respect to the degree of decreasing the load of the second probe 120. In addition, in the case in which the third contact pressure needs to be increased, the contract pressure comparing unit 220 may generate the third load controlling signal including the data with respect to the degree of increasing the load of the third probe 130. In addition, the contract pressure comparing unit 220 may generate the first load controlling signal and the fourth load controlling signal including the data with respect to the load maintenance of the first probe 110 and the fourth probe 140.

The contact pressure comparing unit 220 may transmit the first load controlling signal through the fourth load controlling signal generated as described above to the load controlling unit 230. The load controlling unit 230 may selectively control the loads across the first probe 110 through the fourth probe 140, respectively, depending on the load controlling signal received from the contact pressure comparing unit 220.

The load controlling unit 230 may include a first load controlling unit 231 through a fourth load controlling unit 234. The first load controlling unit 231 may adjust the load across the first probe 110 depending on the first load controlling signal. The second load controlling unit 232 may adjust the load across the second probe 120 depending on the second load controlling signal. The third load controlling unit 233 may adjust the load across the third probe 130 depending on the third load controlling signal. The fourth load controlling unit 234 may adjust the load across the fourth probe 140 depending on the fourth load controlling signal.

The timer 600 may generate a measurement start signal informing a thickness measurement point in time of the metal film. The timer 600 may control the measurement point in time so as to start the thickness measurement of the metal film when all the contact pressure between the metal film and the four-terminal probe 100 are equal to one another. The timer 600 may generate the measurement start signal when receiving a contact complete signal from the contact pressure controlling unit 200. The measurement start signal may be transmitted to the current supplying unit 300 or the voltage measuring unit 400.

The current supplying unit 300 may supply a current to the four-terminal probe 100. The current supplying unit 300 may supply the current to the metal film through the two probes of the four-terminal probe 100.

The voltage measuring unit 400 may measure a voltage applied to the four-terminal probe 100. The voltage applied to the four-terminal probe 100 is an applied voltage of the metal film supplied with the current. Therefore, the voltage measuring unit 400 may measure the voltage across the metal film by measuring the voltage applied to the four-terminal probe 100.

According to the preferred embodiment of the present invention, the timer 600 may transmit the measurement start signal to the current supplying unit 300. In this case, the current supplying unit 300 may supply the current to the four-terminal probe 100 when receiving the measurement start signal. The voltage measuring unit 400 may measure the voltage applied to the four-terminal probe 100 after the current supplying unit 300 supplies the current to the four-terminal probe 100.

Alternatively, the timer 600 may transmit the measurement start signal to the voltage measuring unit 400. In this case, the current supplying unit 300 may supply the current to the four-terminal probe 100 irrespective of the measurement start signal. The voltage measuring unit 400 may start a measurement of the voltage applied to the four-terminal probe 100 when receiving the measurement start signal in a state in which the current is supplied to the four-terminal probe 100.

The thickness calculating unit 500 may calculate the thickness of the metal film. The thickness calculating unit 500 may calculate the thickness of the metal film using the current supplied from the current supplying unit 300 and the voltage measured by the voltage measuring unit. For example, the thickness calculating unit 500 may calculate a resistance value of the metal film using a current value supplied to the four-terminal probe 100 from the current supplying unit 300 and a voltage value across the four-terminal probe 100. In addition, the thickness calculating unit 500 may multiply the resistance value of the metal film with a correction factor of the corresponding metal film to thereby calculate a sheet resistance value. The thickness calculating unit 500 may divide a specific resistance value by the calculated sheet resistance value to thereby calculate the thickness of the metal film.

The thickness measurement device 2000 according to another preferred embodiment of the present invention controls the contact resistances between the four-terminal probe 100 and the metal film so as to be equal by the contact pressure controlling unit 200, thereby making it possible to accurately calculate the thickness of the metal film.

In addition, the thickness measurement device 2000 according to another preferred embodiment of the present invention measures the thickness of the metal film after the contact resistances between the four-terminal probe 100 and the metal film are controlled so as to be equal to one another using the timer 600, thereby making it possible to more accurately calculate the thickness of the metal film.

Although not shown in the present invention, the thickness measurement device 2000 may further include an outputting unit displaying the calculated thickness, a storing unit in which an amount of current supplied to calculate the thickness, the correction factor of the metal film, the specific resistance value, and the like are stored, an inputting unit capable of inputting other instruction or the like, and the like. This may be collectively performed in one configuration unit or may be selectively configured according to a selection of a person skilled in the art.

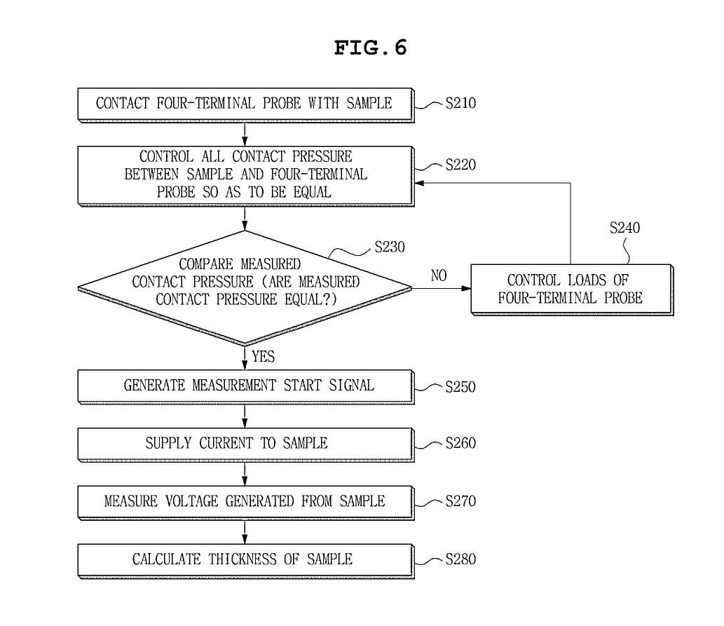

FIG. 6 is an illustration view showing a method for measuring a thickness according to another preferred embodiment of the present invention.

FIG. 6 shows the method for measuring the thickness of the metal film using the thickness measurement device according to another preferred embodiment of the present invention.

First, the four-terminal probe of the thickness measurement device may be in contact with the metal film (S210). For example, the metal film may be a circuit pattern formed on a printed circuit board. The four-terminal probe may be configured by the first probe through the fourth probe. In this case, the first probe through the fourth probe may be configured so as to include variable units having elastic force. The first probe through the fourth probe may be in contact with the surface of the metal film by the variable units.

Next, the thickness measurement device may measure all the contact pressure between the four-terminal probe and the metal film (S220). The contact pressure measuring unit may each measure the contact pressure applied to the first probe through the fourth probe from the metal film. Here, the contact pressure of the first probe through the fourth probe may be the first contact pressure through the fourth contact pressure.

Next, the thickness measurement device may compare the measured contact pressure with one another (S230). The contact pressure comparing unit may compare the first contact pressure through the fourth contact pressure to thereby determine whether or not all the first contact pressure through the fourth contact pressure are equal. The contact pressure comparing unit 220 may generate a contact complete signal when all the first contact pressure through the fourth contact pressure are equal. The contact pressure comparing unit 220 may transmit the generated contact complete signal to the timer. The contact pressure comparing unit 220 may generate a load controlling signal when the first contact pressure through the fourth contact pressure are not equal. The contact pressure comparing unit 220 may transmit the load controlling signal to the load controlling unit.

Next, when all the contact pressure are not equal according to the comparison result of the contact pressure, the thickness measurement device may control the loads of the four-terminal probe (S240). The load controlling unit may adjust the loads of the first probe through the fourth probe when receiving the load controlling signal from the contact pressure comparing unit. The load controlling unit may each adjust the loads of the first probe through the fourth probe depending on the received load controlling signal. When the loads of the first probe through the fourth probe are adjusted by the load controlling unit as described above, the thickness measurement device may again perform S220. The thickness measurement device may repeatedly perform S220 through S240 until the contract pressure measuring unit generates the contact complete signal.

Next, the thickness measurement device may generate a measurement start signal (S250). The contact pressure measuring unit may transmit the contact complete signal to the timer. The timer 600 may generate the measurement start signal informing a thickness measurement point in time of the metal film when receiving the contact complete signal. That is, the timer may control the measurement point in time so as to start the thickness measurement of the metal film when all the contact pressure between the metal film and the four-terminal probe are equal to one another. The timer may transmit the measurement start signal to the current supplying unit.

Next, the thickness measurement device may supply a current to the metal film (S260). The current supplying unit may supply the current to the four-terminal probe when receiving the measurement start signal from the timer. The current supplying unit may supply the current to the metal film through two probes of the first probe through the fourth probe.

Next, the thickness measurement device may measure a voltage generated from the metal film (S270). The voltage measuring unit may measure the voltage generated from the metal film by the current supplied to the metal film. In this case, the voltage generated from the metal film may be applied to the two probes of the four-terminal probe. Therefore, the voltage measuring unit may measure the voltage generated from the metal film by measuring the voltage across the two probes.

Next, the thickness measurement device may calculate the thickness of the metal film (S280). The thickness calculating unit may calculate a resistance value of the metal film using the current supplied to the metal film and the voltage measured from the metal film. In addition, the thickness calculating unit may multiply the resistance value of the metal film with a correction factor of the corresponding metal film to thereby calculate a sheet resistance value. In addition, the thickness calculating unit may divide a specific resistance value of the metal film by the calculated sheet resistance value to thereby calculate the thickness of the metal film.

Although another preferred embodiment of the present invention has described that the supplying of the current to the metal film (S260) is performed after the generating of the measurement start signal (S250), the present invention is not limited thereto. If the measurement start signal is transmitted to the voltage measuring unit rather than the current supplying unit, the generating of the measurement start signal (S250) may be performed at any operation before the supplying of the current to the metal film (S260).

The method for measuring the thickness according to another preferred embodiment of the present invention may decrease an error in the thickness caused by the different contact resistance between the metal film and the four-terminal probe by the adjusting of the contact pressure between the metal film and the four-terminal probe so as to be equal. In addition, the thickness measurement device according to another preferred embodiment of the present invention measures the thickness of the metal film after all the contact pressure between the four-terminal probe and the metal film are equal to one another, thereby making it possible to accurately measure the thickness of the metal film.

According to the preferred embodiment of the present invention, the thickness measurement device and the method for measuring a thickness make all the contact pressure between the metal film and the four-terminal probe equal to one another, thereby making it possible to accurately measure the thickness of the metal film.

Although the embodiments of the present invention have been disclosed for illustrative purposes, it will be appreciated that the present invention is not limited thereto, and those skilled in the art will appreciate that various modifications, additions and substitutions are possible, without departing from the scope and spirit of the invention.

Accordingly, any and all modifications, variations or equivalent arrangements should be considered to be within the scope of the invention, and the detailed scope of the invention will be disclosed by the accompanying claims.

What is claimed is:

1. A thickness measurement device, comprising:
a four-terminal probe including a first probe through a fourth probe which are in contact with a metal film;
a contact pressure controlling unit each controlling the first probe through the fourth probe so that the metal film and the first probe through the fourth probe have the same contact pressure;
a current supplying unit supplying a current to the four-terminal probe;
a voltage measuring unit measuring a voltage across the four-terminal probe; and
a thickness calculating unit calculating a thickness of the metal film using a current value supplied from the current supplying unit and a voltage value measured by the voltage measuring unit.

2. The thickness measurement device as set forth in claim 1, wherein the contact pressure controlling unit includes:
a contact pressure measuring unit measuring contact pressure each applied to the first probe through the fourth probe from the metal film;
a contact pressure comparing unit comparing the respective contact pressure of the first probe through the fourth probe measured from the contact pressure measuring unit; and
a load controlling unit selectively controlling loads applied to the first probe through the fourth probe depending on a result of the contact pressure comparing unit.

3. The thickness measurement device as set forth in claim 2, wherein the load controlling unit selectively controls the loads of the first probe through the fourth probe, respectively.

4. The thickness measurement device as set forth in claim 1, further comprising variable units each formed on the first probe through the fourth probe to thereby allow the first probe through the fourth probe to be in contact with a surface of the metal film.

5. The thickness measurement device as set forth in claim 4, wherein the variable unit is made of elastic material.

6. The thickness measurement device as set forth in claim 1, further comprising a timer generating a measurement start signal controlling a thickness measurement point in time of the metal film, when the first probe through the fourth probe have the same contact pressure.

7. The thickness measurement device as set forth in claim 6, wherein the timer transmits the measurement start signal to the current supplying unit.

8. The thickness measurement device as set forth in claim 7, wherein the current supplying unit supplies the current to the four-terminal probe when receiving the measurement start signal.

9. The thickness measurement device as set forth in claim 6, wherein the timer transmits the measurement start signal to the voltage measuring unit.

10. The thickness measurement device as set forth in claim 9, wherein the voltage measuring unit measures the voltage applied to the four-terminal probe when receiving the measurement start signal.

11. The thickness measurement device as set forth in claim 1, wherein the thickness calculating unit calculates the thickness of the metal film using a sheet resistance value calculated using the current value and the voltage value and a specific resistance value of the metal film.

12. The thickness measurement device as set forth in claim 1, wherein the current supplying unit supplies the current to the metal film through two probes of the four-terminal probe.

13. The thickness measurement device as set forth in claim 1, wherein the voltage measuring unit measures the voltage applied to two probes of the four-terminal probe.

14. A method for measuring a thickness, the method comprising:
contacting a metal film with a four-terminal probe including a first probe through a fourth probe;
controlling contact pressure between the metal film and the first probe through the fourth probe so as to be equal;
supplying a current to the four-terminal probe;
measuring a voltage applied to the four-terminal probe; and
calculating a thickness of the metal film using a current value and a voltage value.

15. The method as set forth in claim 14, wherein the controlling of the contact pressure so as to be equal includes:
measuring contact pressure each applied to the first probe through the fourth probe from the metal film;
comparing the measured contact pressure of the first probe through the fourth probe; and
controlling loads each applied to the first probe through the fourth probe depending on a result of the comparison.

16. The method as set forth in claim 15, wherein the controlling of the contact pressure so as to be equal is repeatedly performed until the measured contact pressure of the first probe through the fourth probe are equal.

17. The method as set forth in claim 14, wherein in the contacting of the metal film with the four-terminal probe, the first probe through the fourth probe are in contact with a surface of the metal film.

18. The method as set forth in claim 14, wherein in the contacting of the metal film with the four-terminal probe, the first probe through the fourth probe have variable bodies so as to be in contact with a surface of the metal film.

19. The method as set forth in claim 14, wherein the variable bodies of the first probe through the fourth probe are formed of elastic material.

20. The method as set forth in claim 14, further comprising, after the controlling of the contact pressure so as to be equal, generating a measurement start signal controlling a thickness measurement point in time of the metal film when the contact pressure of the first probe through the fourth probe are equal.

21. The method as set forth in claim 14, wherein in the measuring of the thickness of the metal film, a thickness of the metal film is calculated using a sheet resistance value calculated using the current value and the voltage value and a specific resistance value of the metal film.

22. The method as set forth in claim 14, wherein in the supplying of the current, the current is applied to the metal film through two probes of the four-terminal probe.

23. The method as set forth in claim 14, wherein in the measuring of the voltage, the voltage applied to two probes of the four-terminal probe is measured.
